(19) United States
(12) Patent Application Publication
(10) Pub. No.: US 2015/0084847 A1
(43) Pub. Date: Mar. 26, 2015

(54) DC-DC CONVERTER AND DISPLAY APPARATUS HAVING THE SAME

(71) Applicants: Min-Woo KIM, Suwon-si (KR); Hyun-Il PARK, Hwaseong-si (KR); Sang-Rock YOON, Hwaseong-si (KR); On-Sik CHOI, Hwaseong-si (KR)

(72) Inventors: Min-Woo KIM, Suwon-si (KR); Hyun-Il PARK, Hwaseong-si (KR); Sang-Rock YOON, Hwaseong-si (KR); On-Sik CHOI, Hwaseong-si (KR)

(73) Assignee: Samsung Display Co., LTD., Yongin-City (KR)

(21) Appl. No.: 14/493,760

(22) Filed: Sep. 23, 2014

(30) Foreign Application Priority Data
Sep. 26, 2013 (KR) 10-2013-0114219

(51) Int. Cl. H02M 3/156; G09G 3/36; H02M 1/44

(52) U.S. Cl. CPC H02M 3/156; H02M 1/44; G09G 3/3648; G09G 2310/0289
USPC 345/98; 323/282

(57) ABSTRACT

A direct-current-to-direct-current (“DC-DC”) converter includes an inductor to which an input voltage is applied, a diode connected to the inductor, a switching element connected between the inductor and the diode, a capacitor group disposed adjacent to the diode and comprising one or more capacitors, and an output voltage pattern connected to the diode and the capacitor group and which outputs an output voltage, where the capacitor group covers a first side of the output voltage pattern and a second side of the output voltage pattern opposite to the first side of the output voltage pattern.

This application claims priority to Korean Patent Application No. 10-2013-0114219, filed on Sep. 26, 2013, and all the benefits accruing therefrom under 35 U.S.C. § 119, the content of which are incorporated by reference herein in its entirety.

### BACKGROUND

1. Field

Exemplary embodiments of the invention relate to a direct current-to-direct current (“DC-DC”) converter and a display apparatus including the DC-DC converter. More particularly, exemplary embodiments of the invention relate to a DC-DC converter with reduced electromagnetic interference (“EMI”) and a display apparatus including the DC-DC converter.

2. Description of the Related Art

Generally, a liquid crystal display (“LCD”) apparatus includes a first substrate including a pixel electrode, a second substrate including a common electrode and a liquid crystal layer disposed between the first and second substrate. In such an LCD, an electric field is generated by voltages applied to the pixel electrode and the common electrode. By adjusting an intensity of the electric field, a transmittance of a light passing through the liquid crystal layer may be adjusted such that a desired image may be displayed.

Generally, a display apparatus includes a display panel and a display panel driver to drive the display panel. The display apparatus further includes a direct-current-to-direct-current (“DC-DC”) converter to change a voltage level. The pulse width modulation (“PWM”) converter has been generally used for the DC-DC converter.

The PWM converter has a relatively high efficiency, while the PWM converter may have relatively high electromagnetic interference (“EMI”).

### SUMMARY

In a display apparatus which implements mobile communication, quality of communication may be deteriorated when a direct current-to-direct current (“DC-DC”) converter included therein has high electromagnetic interference (“EMI”).

Exemplary embodiments of the invention provide a DC-DC converter with reduced EMI.

Exemplary embodiments of the invention also provide a display apparatus including the DC-DC converter.

In an exemplary embodiment of the invention, a DC-DC converter includes an inductor, a diode, a switching element, a capacitor group and an output voltage pattern. An input voltage is applied to the inductor. The diode is connected to the inductor. The switching element is connected between the inductor and the diode. The capacitor group is disposed adjacent to the diode and includes one or more capacitors. The output voltage pattern is connected to the diode and the capacitor group and outputs an output voltage. The capacitor group covers a first side of the output voltage pattern and a second side of the output voltage pattern opposite to the first side of the output voltage pattern.

In an exemplary embodiment, the capacitor group may include a capacitor which covers the first side and the second side of the output voltage pattern.

In an exemplary embodiment, the capacitor group may include a first capacitor which covers the first side of the output voltage pattern, and a second capacitor which covers the second side of the output voltage pattern.

In an exemplary embodiment, the inductor may include a first end to which the input voltage is applied, and a second end connected to a first electrode of the diode. The diode may include the first electrode connected to the second end of the inductor, and a second electrode connected to a first end of the capacitor group. The switching element may include a control electrode connected to a driving circuit, an input electrode connected to the first electrode of the diode, and an output electrode to which a ground voltage is applied. The capacitor group may include the first end connected to the second electrode of the diode, and a second end to which the ground voltage is applied.

In an exemplary embodiment, the DC-DC converter may further include a first resistor including a first end connected to the first end of the capacitor group and a second end connected to a feedback node, and a second resistor including a first end connected to the feedback node, and a second end to which the ground voltage is applied. The feedback node may be connected to the driving circuit.

In an exemplary embodiment, the first end of the first resistor may be connected to the output voltage pattern. The first end of the first resistor may be disposed on an opposite side of the diode with respect to the capacitor group.

In an exemplary embodiment, the capacitor group may include a multilayer ceramic capacitor.

In an exemplary embodiment, the diode may have a parasitic capacitance equal to or greater than about 30 picofarads (pF) when a reverse voltage of the diode is about 30 volts (V).

In an exemplary embodiment, the DC-DC converter may be operated in a boundary current mode (“BCM) corresponding to a boundary of a continuous current mode (”CCM”) and a discontinuous current mode (“DCM”).

In an exemplary embodiment of a display apparatus, according to the invention, the display apparatus includes a display panel, a DC-DC converter and a display panel driver. The display panel displays an image. The DC-DC converter includes an inductor, a diode, a switching element, a capacitor group and an output voltage pattern. An input voltage is applied to the inductor. The diode is connected to the inductor. The switching element is connected between the inductor and the diode. The capacitor group is disposed adjacent to the diode and includes one or more capacitors. The output voltage pattern is connected to the diode and the capacitor group and outputs an output voltage. The display panel driver drives the display panel using the output voltage of the DC-DC converter. The capacitor group covers a first side of the output voltage pattern and a second side of the output voltage pattern opposite to the first side of the output voltage pattern.

In an exemplary embodiment, the display apparatus may further include a light source part which provides light to the display panel, and a light source driver which drives the light source part using the output voltage of the DC-DC converter.

In an exemplary embodiment, the capacitor group may include a capacitor which covers the first side and the second side of the output voltage pattern.

In an exemplary embodiment, the capacitor group may include a first capacitor which covers the first side of the output voltage pattern, and a second capacitor which covers the second side of the output voltage pattern.

In an exemplary embodiment, the inductor may include a first end to which the input voltage is applied, and a second end connected to a first electrode of the diode. The diode may include the first electrode connected to the second end of the inductor, and a second electrode connected to a first end of the capacitor group. The switching element may include a control electrode connected to a driving circuit, an input electrode connected to the first electrode of the diode, and an output electrode to which a ground voltage is applied. The capacitor group may include the first end connected to the second electrode of the diode, and a second end to which the ground voltage is applied.

In an exemplary embodiment, the DC-DC converter may further include a first resistor including a first end connected to the first end of the capacitor group and a second end connected to a feedback node, and a second resistor including a first end connected to the feedback node and a second end to which the ground voltage is applied. The feedback node may be connected to the driving circuit.

In an exemplary embodiment, the first end of the first resistor may be connected to the output voltage pattern. The first end of the first resistor may be disposed on an opposite side of the diode with respect to the capacitor group.

In an exemplary embodiment, the diode may have a parasitic capacitance equal to or greater than about 30 pF when a reverse voltage of the diode is about 30 V.

In an exemplary embodiment, the DC-DC converter may be operated in a BCM corresponding to a boundary of a CCM and a DCM.

According to exemplary embodiments of the DC-DC converter and the display apparatus including the DC-DC converter, the DC-DC converter includes a capacitor group disposed adjacent to the diode and covering first and second sides of the output voltage pattern such that EMI may be reduced due to a reverse current of the diode.

### BRIEF DESCRIPTION OF THE DRAWINGS

The above and other features of the invention will become more apparent by describing in detailed exemplary embodiments thereof with reference to the accompanying drawings, in which:

FIG. 1 is a block diagram illustrating an exemplary embodiment of a display apparatus, according to the invention;

FIG. 2 is a circuit diagram illustrating an exemplary embodiment of a direct current-to-direct current (“DC-DC”) converter of FIG. 1;

FIG. 3 is a plan view illustrating a layout of an exemplary embodiment of the DC-DC converter of FIG. 1;

FIG. 4 is an equivalent circuit diagram illustrating an alternative exemplary embodiment of the DC-DC converter of FIG. 1;

FIG. 5 is an equivalent circuit diagram illustrating an exemplary embodiment of the DC-DC converter of FIG. 1 when a switching element of FIG. 2 is turned on;

FIG. 6A is a graph illustrating a parasitic capacitance due to a reverse voltage of a first diode which is employed as the diode of the DC-DC converter shown in FIG. 2;

FIG. 6B is a graph illustrating a parasitic capacitance due to a reverse voltage of a second diode which is employed as the diode of the DC-DC converter shown in FIG. 2;

FIG. 6C is a graph illustrating a parasitic capacitance due to a reverse voltage of a third diode which is employed as the diode of the DC-DC converter shown in FIG. 2;

FIG. 7 is a graph illustrating an impedance of the first to third diodes of FIGS. 6A to 6C according to a frequency;

FIG. 8A is a graph illustrating a discontinuous current mode among a driving mode of the DC-DC converter of FIG. 1;

FIG. 8B is a graph illustrating a boundary current mode among a driving mode of the DC-DC converter of FIG. 1;

FIG. 8C is a graph illustrating a continuous current mode among a driving mode of the DC-DC converter of FIG. 1;

FIG. 9 is a circuit diagram illustrating an alternative exemplary embodiment of a DC-DC converter, according to the invention; and

FIG. 10 is a plan view illustrating a layout of an exemplary embodiment of the DC-DC converter of FIG. 9.

### DETAILED DESCRIPTION

The invention now will be described more fully hereinafter with reference to the accompanying drawings, in which various embodiments are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings herein.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. “Or” means “and/or.” It will be further understood that the terms “comprises” and/or “comprising,” or “includes” and/or “including” when used in this specification, specify the presence of stated features, integers, steps, operations, elements, and/or components, but do not preclude the presence or addition of one or more other features, integers, steps, operations, elements, components, and/or groups thereof

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Exemplary embodiments are described herein with reference to cross sectional illustrations that are schematic illustrations of illustratively idealized example embodiments (and intermediate structures) of the invention. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the invention will be described in detail with reference to the accompanying drawings.

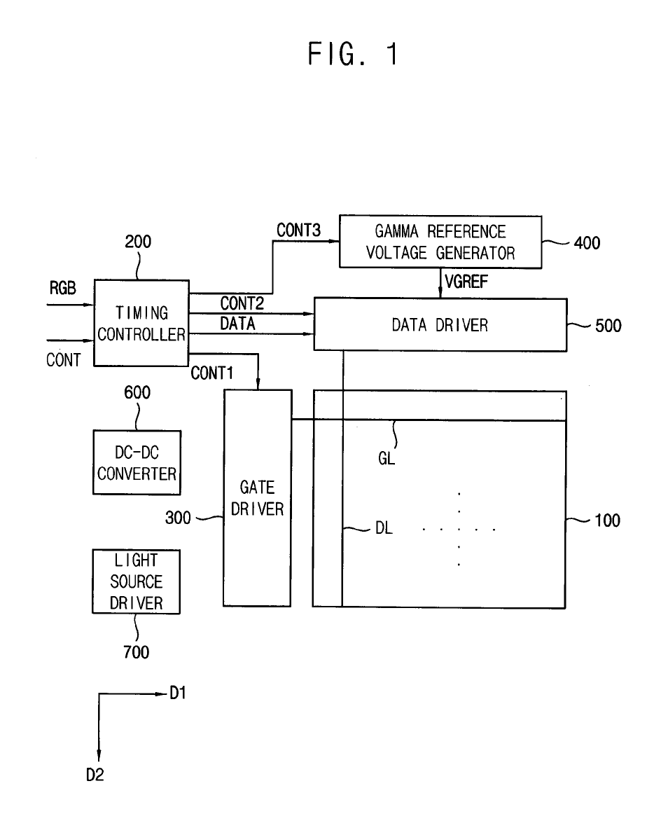

FIG. 1 is a block diagram illustrating an exemplary embodiment of a display apparatus, according to the invention.

Referring to FIG. 1, an exemplary embodiment of the display apparatus includes a display panel 100, a display panel driver, a direct-current-to-direct-current (“DC-DC”) converter 600 and a light source driver 700. The display panel driver includes a timing controller 200, a gate driver 300, a gamma reference voltage generator 400 and a data driver 500.

The display panel 100 includes a display region on which an image is displayed and a peripheral region adjacent to the display region.

The display panel 100 includes a plurality of gate lines GL, a plurality of data lines DL and a plurality of unit pixels connected to the gate lines GL and the data lines DL. The gate lines GL extend substantially in a first direction D1. The data lines DL extend substantially in a second direction D2 crossing the first direction D1.

The timing controller 200 receives input image data RGB and an input control signal CONT from an external apparatus (not shown). The input image data may include red image data R, green image data G and blue image data B. The input control signal CONT may include a master clock signal and a data enable signal. The input control signal CONT may further include a vertical synchronizing signal and a horizontal synchronizing signal.

The timing controller 200 generates a first control signal CONT1, a second control signal CONT2, a third control signal CONT3 and a data signal DATA based on the input image data RGB and the input control signal CONT.

The timing controller 200 generates the first control signal CONT1 for controlling an operation of the gate driver 300 based on the input control signal CONT, and outputs the first control signal CONT1 to the gate driver 300. The first control signal CONT1 may further include a vertical start signal and a gate clock signal.

The timing controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The timing controller 200 generates the data signal DATA based on the input image data RGB. The timing controller 200 outputs the data signal DATA to the data driver 500.

The timing controller 200 generates the third control signal CONT3 for controlling an operation of the gamma reference voltage generator 400 based on the input control signal CONT, and outputs the third control signal CONT3 to the gamma reference voltage generator 400.

The gate driver 300 generates gate signals for driving the gate lines GL in response to the first control signal CONT1 received from the timing controller 200. The gate driver 300 sequentially outputs the gate signals to the gate lines GL.

The gamma reference voltage generator 400 generates a gamma reference voltage VGREF in response to the third control signal CONT3 received from the timing controller 200. The gamma reference voltage generator 400 provides the gamma reference voltage VGREF to the data driver 500. The gamma reference voltage VGREF has a value corresponding to a level of the data signal DATA.

The data driver 500 receives the second control signal CONT2 and the data signal DATA from the timing controller 200, and receives the gamma reference voltages VGREF from the gamma reference voltage generator 400. The data driver 500 converts the data signal DATA into data voltages of analog type using the gamma reference voltages VGREF. The data driver 500 sequentially outputs the data voltages to the data lines DL.

The DC-DC converter 600 converts an input voltage into an output voltage. The DC-DC converter 600 may boost the input voltage to generate the output voltage which is greater than the input voltage. The DC-DC converter 600 may decrease the input voltage to generate the output voltage which is less than the input voltage.

The DC-DC converter 600 may provide the output voltage to the display panel driver. The DC-DC converter 600 may provide the output voltage to the light source driver 700.

In one exemplary embodiment, for example, the DC-DC converter 600 may be a pulse width modulation (“PWM”) converter using a pulse width modulation method.

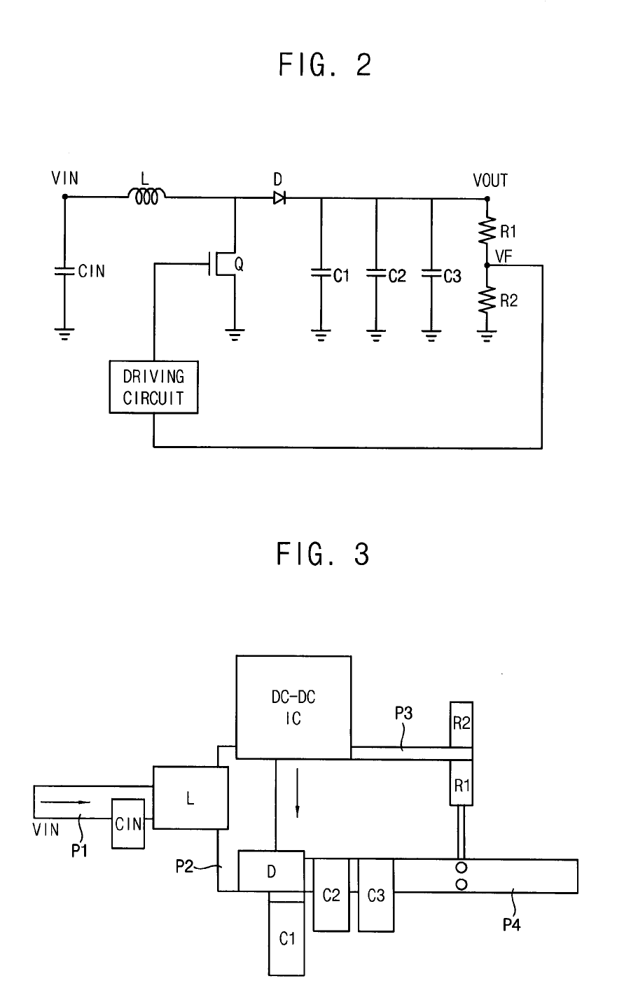

A structure and an operation of the DC-DC converter 600 will be described later in greater detail referring to FIGS. 2 to 8C.

The light source driver 700 is connected to a light source part and provides a driving voltage to the light source part. The light source driver 700 may drive the light source part using the output voltage VOUT.

In one exemplary embodiment, for example, the light source part may include at least one of a cold cathode fluorescent lamp (“CCFL”), an external electrode fluorescent lamp (“EEFL”), a flat fluorescent lamp (“FFL”) and a light emitting diode (“LED”).

FIG. 2 is a circuit diagram illustrating an exemplary embodiment of the DC-DC converter 600 of FIG. 1. FIG. 3 is a plan view illustrating a layout of an exemplary embodiment of the DC-DC converter 600 of FIG. 1.

Referring to FIGS. 1 to 3, the DC-DC converter 600 includes an inductor L to which an input voltage VIN is applied, a diode D connected to the inductor L, a switching element Q connected between the inductor L and the diode D, a capacitor group C1, C2 and C3 adjacent to the diode D, connected to the diode D and including one or more capacitors, e.g., first to third capacitors C1 to C3. The DC-DC converter 600 may further include an input capacitor CIN for charging the input voltage VIN.

In one exemplary embodiment, for example, the inductor L includes a first end, to which the input voltage VIN is applied, and a second end connected to a first electrode of the diode D. The diode D includes the first electrode connected to the second end of the inductor L and a second electrode connected to a first end of the capacitor group C1, C2 and C3. The switching element Q include a control electrode connected to a driving circuit, an input electrode connected to the first electrode of the diode and an output electrode to which a ground voltage is applied. The capacitor group C1, C2 and C3 includes the first end connected to the second electrode of the diode D and a second end to which the ground voltage is applied.

The DC-DC converter 600 further includes a first resistor R1 and a second resistor R2. The first resistor R1 includes a first end connected to the first end of the capacitor group C1, C2 and C3 and a second end connected to a feedback node. The second resistor R2 includes a first end connected to the feedback node and a second end to which the ground voltage is applied.

A feedback voltage VF at the feedback node is applied to the driving circuit. The driving circuit controls the switching element Q based on the feedback voltage VF. The switching element Q may be turned on or off based on the feedback voltage VF by the driving circuit.

In an exemplary embodiment, as shown in FIG. 3, the input voltage VIN is applied to the inductor L through an input voltage pattern P1. The inductor L and the input capacitor CIN are disposed on the input voltage pattern P1.

The inductor L partially overlaps a switching pattern P2. The switching pattern P2 connected to the diode D and a DC-DC integrated circuit (“IC”). The DC-DC IC may be on a single chip. The DC-DC IC may include the switching element Q and the driving circuit.

The diode D overlaps an output voltage pattern P4. In an exemplary embodiment, the capacitors C1, C2 and C3 in the capacitor group are disposed adjacent to the diode D. In such an embodiment, when the switching element Q is turned off, a reverse current flowing through the diode D may be effectively prevented by the capacitors C1, C2 and C3 in the capacitor group. In such an embodiment, a high frequency ripple of the current flowing through the diode D may be effectively removed by the capacitors C1, C2 and C3 in the capacitor group.

In an exemplary embodiment, the DC-DC converter may be driven in a relatively low power. In such a low power DC-DC converter, a width of the output voltage pattern P4 may be less than a predetermined width, e.g., about 1.6 millimeters (mm)

In an exemplary embodiment, the capacitor group C1, C2 and C3 covers a first long side of the output voltage pattern P4 and a second long side of the output voltage pattern P4 opposite to the first long side of the output voltage pattern P4. In such an embodiment, as shown in FIG. 3, the second capacitor C2 and the third capacitor C3 may cover both of the first long side (an upper side) of the output voltage pattern P4 and the second long side (a lower side) of the output voltage pattern P4. In such an embodiment, the second and third capacitors C2 and C3 may extend from the first long side of the output voltage pattern P4 in a width direction of the output voltage pattern P4 via the second long side of the output voltage pattern P4.

In one exemplary embodiment, for example, the second and third capacitors C2 and C3 may entirely cover a width of the output voltage pattern P4 as shown in FIG. 3. The second and third capacitors C2 and C3 may be bonded on the output voltage pattern P4 to entirely cover the width of the output voltage pattern P4.

In one exemplary embodiment, for example, the capacitor group may include a multilayer ceramic capacitor (“MLCC”). Each of the first to third capacitors C1, C2 and C3 may be the MLCC.

The DC-DC converter 600 includes a feedback pattern P3 that connects the DC-DC IC and the feedback node.

The first and second resistors R1 and R2 feedbacks the output voltage VOUT of the output voltage pattern P4 to the DC-DC IC by a voltage dividing method. In an exemplary embodiment, the output voltage VOUT may be extracted at an opposite side of the diode D with respect to the capacitor group C1, C2 and C3 in the output voltage pattern P4. In such an embodiment, the first end of the first resistor R1 is disposed on an opposite side of the diode D with respect to the capacitor group C1, C2 and C3.

When the output voltage VOUT is extracted between the diode D and the capacitor group C1, C2 and C3, the high frequency ripple is not removed from the feedback voltage such that the high frequency ripple may be amplified. Accordingly, the reliability of the DC-DC converter may decrease and the EMI may increase.

In an exemplary embodiment, where the output voltage VOUT is extracted at the opposite side of the diode D with respect to the capacitor group C1, C2 and C3, the feedback voltage VF is extracted based on the output voltage VOUT from which the high frequency ripple is removed. Thus, in such an embodiment, the reliability of the DC-DC converter may be improved and the EMI may decrease.

In an exemplary embodiment, the output voltage VOUT may be extracted on the opposite side of the diode D with respect to the capacitor group C1, C2 and C3 for over voltage protection.

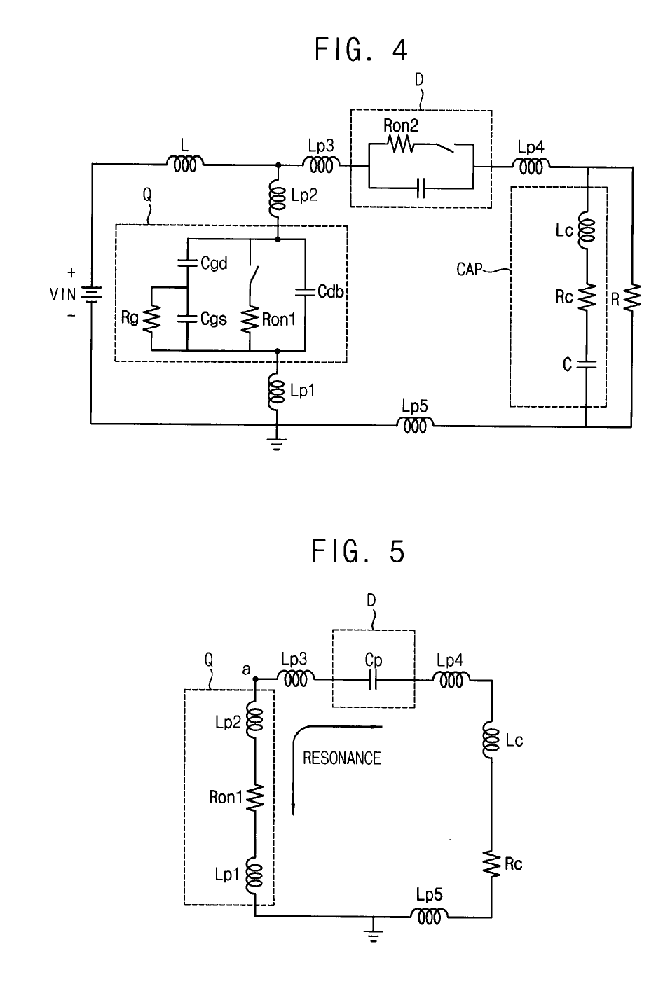

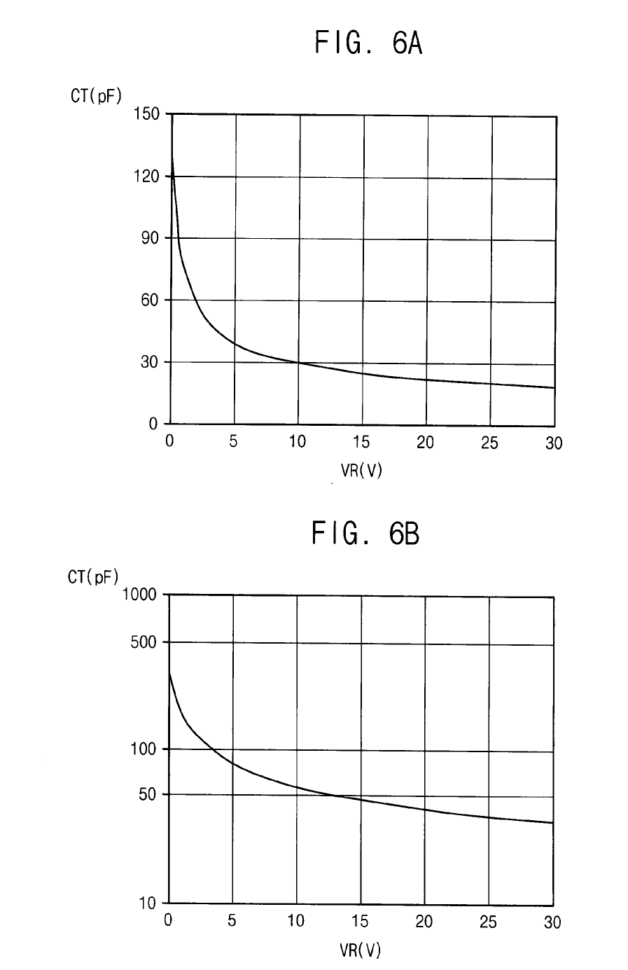

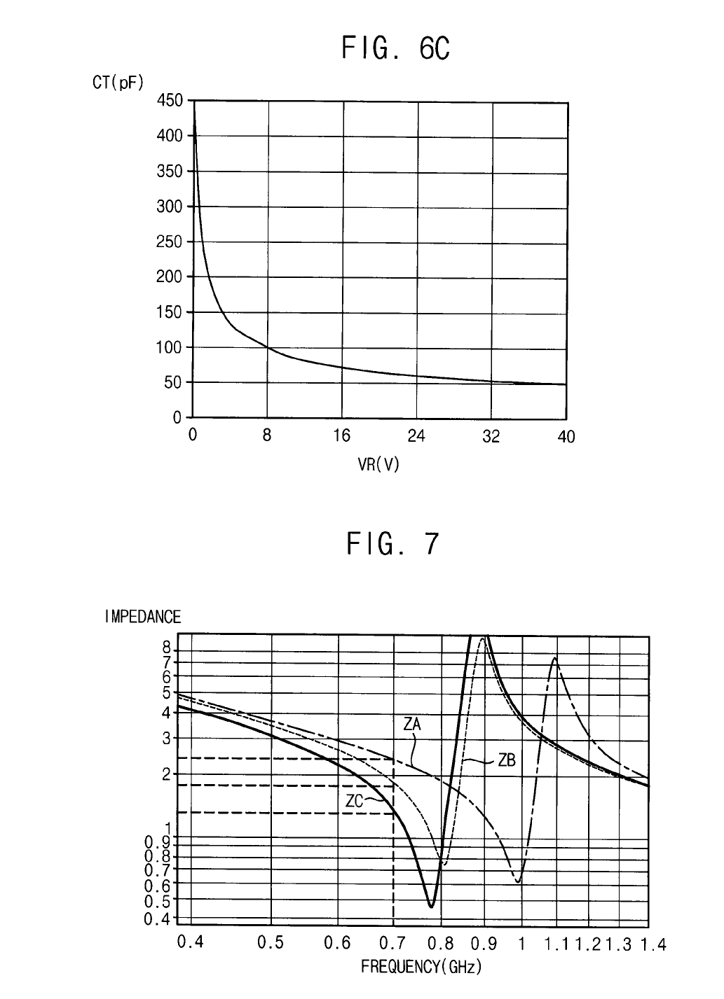

FIG. 4 is an equivalent circuit diagram illustrating an alternative exemplary embodiment of the DC-DC converter 600 of FIG. 1. FIG. 5 is an equivalent circuit diagram illustrating an exemplary embodiment of the DC-DC converter 600 of FIG. 1 when the switching element Q of FIG. 2 is turned on. FIG. 6A is a graph illustrating a parasitic capacitance due to a reverse voltage of a first diode which is employed as the diode D of the DC-DC converter 600 shown in FIG. 2. FIG. 6B is a graph illustrating a parasitic capacitance due to a reverse voltage of a second diode which is employed as the diode D of the DC-DC converter 600 shown in FIG. 2. FIG. 6C is a graph illustrating a parasitic capacitance due to a reverse voltage of a third diode which is employed as the diode D of the DC-DC converter 600 shown in FIG. 2. FIG. 7 is a graph illustrating an impedance of the first to third diodes of FIGS. 6A to 6C according to a frequency.

Hereinafter, a method of selecting the diode D of the DC-DC converter for reducing the EMI will be described referring to FIGS. 4 to 7.

In FIG. 4, an equivalent circuit diagram of an exemplary embodiment of the DC-DC converter 600 is illustrated in detail. In the equivalent circuit diagram, the DC-DC converter 600 is represented by the switching element Q, the diode D, the capacitor group CAP, an inductor L and a resistor R, which are connected to each other via a plurality of inductors Lp1 to Lp5. In the equivalent circuit diagram, the switching element Q may be represented by resistors Rg and Ron1, capacitors Cgd, Cgs and Cdb and a switch.

In the equivalent circuit diagram, the diode D may be represented by a resistor Ron2 and a switch, which are connected to each other in series, and a capacitor connected to the switch in parallel.

In the equivalent circuit diagram, the capacitor group CAP may be represented by an inductor Lc, a resistor Rc and a capacitor C connected to one another in series.

In FIG. 5, an equivalent circuit diagram of an exemplary embodiment of the DC-DC converter 600 is illustrated when the switching element Q is turned on. When the switching element Q is turned on, the PWM waveform may generate falling edge. Accordingly, the high frequency ripple may be generated.

In In the equivalent circuit diagram of FIG. 5, a capacitance of the capacitor Ron1 of the switching element Q has a predetermined value and an inductance of the circuit may not be substantially changed such that the parasitic capacitance Cp of the diode D is determined by a resonance frequency and a quality factor (“Q factor”). Accordingly, when the parasitic capacitance Cp of the diode D increases, the resonance frequency decreases and the Q factor decreases. Thus, when the parasitic capacitance Cp of the diode D increases, the EMI may be reduced.

FIGS. 6A to 6C show the parasitic capacitance of the first to third diodes according to the reverse voltage of the first to third diodes which are employed as the diode D of the exemplary embodiment. FIG. 7 represents an impedance curve according to the frequency of the first to third diodes.

When the reverse voltage VR is about 30 volts (V), the first diode has a total capacitance CT of about 18 picofarads (pF). When the reverse voltage VR is about 30 V, the second diode has a total capacitance CT of about 34 pF. When the reverse voltage VR is about 30 V, the third diode has a total capacitance CT of about 55 pF. The total capacitance CT according to the reverse voltage VR may be substantially the same as the parasitic capacitance according to the reverse voltage VR.

In FIG. 7, the impedance curve of the first diode according to the frequency is labeled with ZA, the impedance curve of the second diode according to the frequency is labeled with ZB and the impedance curve of the third diode according to the frequency is labeled with ZC. In a frequency band of about 700 megahertz (MHz), e.g., a frequency band of long-term evolution/wireless wide area network (“LTE/WWAN”), the first diode has the impedance of about 2.5, the second diode has the impedance of about 1.8, and the third diode has the impedance of about 1.4.

As shown in FIG. 7, a serial resonance frequency of the first diode (in ZA), which has the minimum impedance, is about 1 GHz, a serial resonance frequency of the second diode (in ZB), which has the minimum impedance, is about 0.81 gigahertz (GHz), and a serial resonance frequency of the third diode (in ZC), which has the minimum impedance, is about 0.78 GHz.

Therefore, in an exemplary embodiment, when the diode D having the parasitic capacitance equal to or greater than about 30 pF with respect to the reverse voltage of about 30 V is selected, the EMI may be reduced.

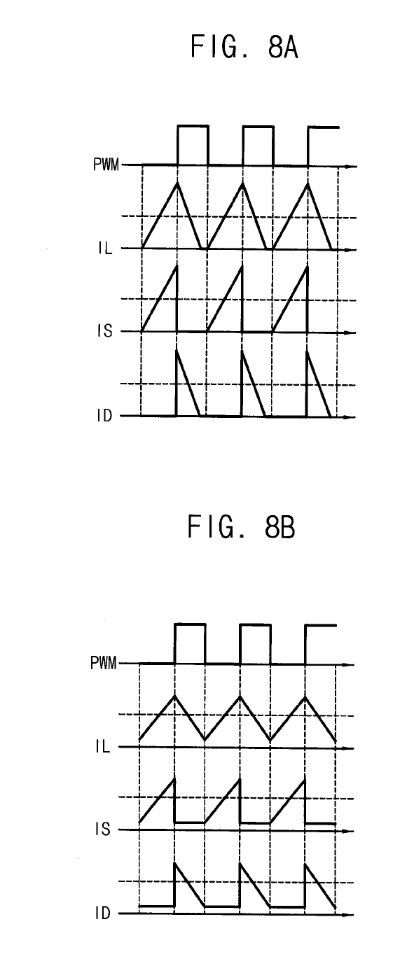

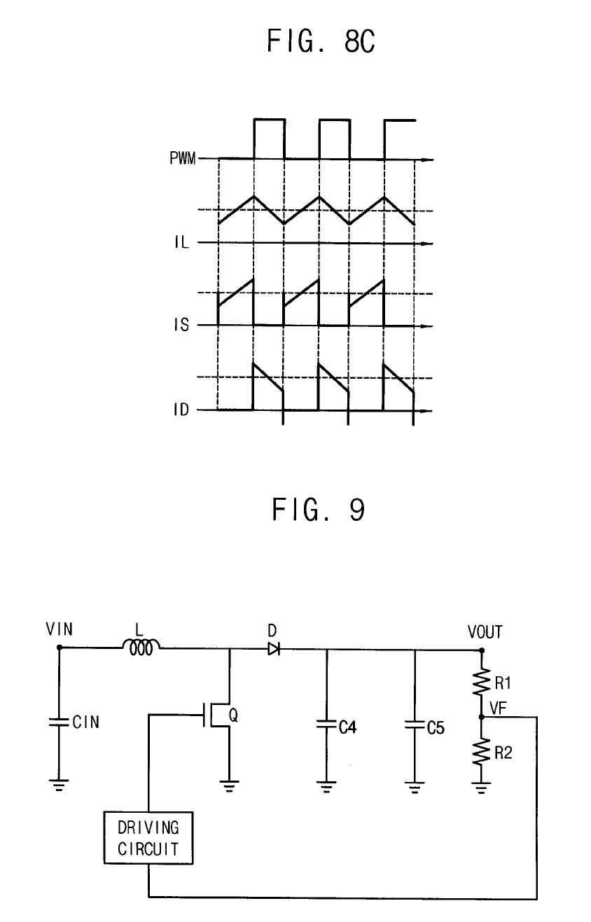

FIG. 8A is a graph illustrating a discontinuous current mode (“DCM”) among a driving mode of the DC-DC converter 600 of FIG. 1. FIG. 8B is a graph illustrating a boundary current mode (“BCM”) among a driving mode of the DC-DC converter 600 of FIG. 1. FIG. 8C is a graph illustrating a continuous current mode (“CCM”) among a driving mode of the DC-DC converter 600 of FIG. 1.

In FIG. 8A, when the PWM signal is in a low level, the switching element Q is turned on, a switch current IS increases, and a diode current ID is about zero.

In FIG. 8A, When the PWM signal is in a high level, the switching element Q is turned off, the switch current IS is about zero, and the diode current ID decreases from a specific level.

In FIG. 8A, When the PWM signal is alternately in the low level and the high level, an inductor current IL, which is a sum of the switch current IS and the diode current ID, repeatedly increases and decreases.

In the DCM, when the PWM signal is in the high level, the diode current ID is about zero and maintained at about zero for a moment. Thus, the inductor current IL is maintained at about zero for a moment, such that the inductor current IL discontinuously increases and decreases as shown in FIG. 8A.

In FIG. 8C, when the PWM signal is in a low level, the switching element Q is turned on, a switch current IS increases, and a diode current ID is about zero. The increment of the switch current IS in the CCM is less than the increment of the switch current IS in the DCM.

In FIG. 8C, when the PWM signal is in a high level, the switching element Q is turned off, the switch current IS is about zero, and the diode current ID decreases from a specific level. The decrement of the switch current IS in the CCM is less than the decrement of the switch current IS in the DCM.

In FIG. 8C, When the PWM signal is repeatedly in the low level and the high level, an inductor current IL, which is a sum of the switch current IS and the diode current ID, repeatedly increases and decreases.

In the CCM, when the PWM signal is in the high level, the diode current ID does not decrease to zero. Thus, the inductor current IL continuously increases and decreases at a level higher than zero.

In FIG. 8B, when the PWM signal is in a low level, the switching element Q is turned on and a switch current IS increases. A diode current ID is about zero. The increment of the switch current IS in the CCM is less than the increment of the switch current IS in the DCM and greater than the increment of the switch current IS in the CCM.

In FIG. 8B, when the PWM signal is in a high level, the switching element Q is turned off, the switch current IS is about zero. The diode current ID decreases from a specific level. The decrement of the switch current IS in the CCM is less than the decrement of the switch current IS in the DCM and greater than the decrement of the switch current IS in the CCM.

In FIG. 8B, when the PWM signal repeats the low level and the high level, an inductor current IL, which is a sum of the switch current IS and the diode current ID, repeatedly increases and decreases.

In the BCM, a characteristic of the inductor current IL represents a boundary between the characteristic of the inductor current IL in the DCM and the characteristic of the inductor current IL in the CCM. When the characteristic of the inductor current IL becomes closer to the CCM, the EMI may increase due to the reverse current flowing through the diode D. When the characteristic of the inductor current IL becomes closer to the DCM, the increment of the switch current IS becomes substantially great such that the high frequency ripple may increase, and the EMI may thereby increase. In an exemplary embodiment, the DC-DC converter is driven to be operated in the BCM, which corresponds to the boundary between the DCM and the CCM, such that an efficiency of the operation of the DC-DC converter 600 may be maximized. Thus, in such an embodiment, the EMI of the DC-DC converter 600 may be substantially reduced in the frequency band of about 700 MHz.

According to an exemplary embodiment, the DC-DC converter 600 includes the capacitor group C1, C2 and C3 disposed adjacent to the diode D and covering the first and second sides of the output voltage pattern P4 such that the EMI may be reduced due to a reverse current of the diode D. In such an embodiment, the diode D having the parasitic capacitance equal to or greater than 30 pF with respect to the reverse voltage of about 30 V is selected such that the EMI may be reduced. In such an embodiment, the DC-DC converter is driven to be operated in the BCM such that the EMI may be reduced.

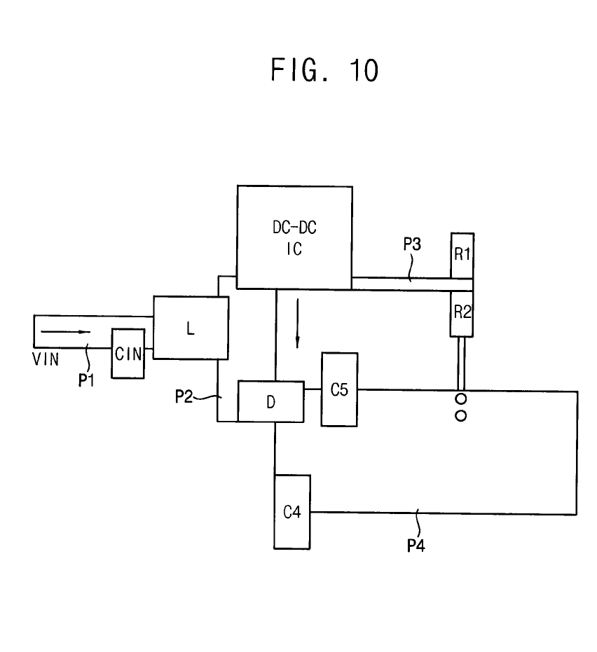

FIG. 9 is a circuit diagram illustrating an alternative exemplary embodiment of a DC-DC converter, according to the invention. FIG. 10 is a plan view illustrating a layout of an exemplary embodiment of the DC-DC converter of FIG. 9.

Hereinafter, an alternative exemplary embodiment of a display apparatus will be described with reference to FIGS. 1, 9 and 10. Such an embodiment of the display apparatus is substantially the same as the exemplary embodiment of the display apparatus described with reference to FIGS. 1 to 8C except for the DC-DC converter. Thus, the same reference numerals will be used to refer to the same or like elements as used above to describe the exemplary embodiment of FIGS. 1 to 8C, and any repetitive detailed description thereof will be omitted or simplified.

Referring to FIGS. 1, 9 and 10, an alternative exemplary embodiment of the display apparatus includes a display panel 100, a display panel driver, a DC-DC converter 600 and a light source driver 700. The display panel driver includes a timing controller 200, a gate driver 300, a gamma reference voltage generator 400 and a data driver 500.

In such an embodiment, as shown in FIG. 9, the DC-DC converter 600 includes an inductor L to which an input voltage VIN is applied, a diode D connected to the inductor L, a switching element Q connected between the inductor L and the diode D, a capacitor group C4 and C5 adjacent to the diode D, connected to the diode D and including one or more capacitors. The DC-DC converter 600 may further include an input capacitor CIN for charging the input voltage VIN.

In one exemplary embodiment, for example, the inductor L includes a first end to which the input voltage VIN is applied and a second end connected to a first electrode of the diode D. The diode D includes the first electrode connected to the second end of the inductor L, and a second electrode connected to a first end of the capacitor group C4 and C5. The switching element Q include a control electrode connected to a driving circuit, an input electrode connected to the first electrode of the diode, and an output electrode to which a ground voltage is applied. The capacitor group C4 and C5 includes the first end connected to the second electrode of the diode D and a second end to which the ground voltage is applied.

The DC-DC converter 600 further includes a first resistor R1 and a second resistor R2. The first resistor R1 includes a first end connected to the first end of the capacitor group C4 and C5 and a second end connected to a feedback node. The second resistor R2 includes a first end connected to the feedback node and a second end to which the ground voltage is applied.

A feedback voltage VF at the feedback node is applied to the driving circuit. The driving circuit controls the switching element Q based on the feedback voltage VF. The switching element Q may be turned on or off based on the feedback voltage VF by the driving circuit.

As shown in FIG. 3, the input voltage VIN is applied to the inductor L through an input voltage pattern P1. The inductor L and the input capacitor CIN are disposed on the input voltage pattern P1.

In such an embodiment, as shown in FIG. 10, the inductor L partially overlaps a switching pattern P2. The switching pattern P2 connected to the diode D and a DC-DC IC. The DC-DC IC may be on a single chip. The DC-DC IC may include the switching element Q and the driving circuit.

The diode D overlaps an output voltage pattern P4. The capacitors C4 and C5 in the capacitor group are disposed adjacent to the diode D. In such an embodiment, when the switching element Q is turned off, a reverse current flowing through the diode D may be effectively prevented by the capacitors C4 and C5 in the capacitor group. In such an embodiment, a high frequency ripple of the current flowing through the diode D may be removed by the capacitors C4 and C5 in the capacitor group.

In an exemplary embodiment, the DC-DC converter may be driven in a relatively high power. In such a high power DC-DC converter, a width of the output voltage pattern P4 may be greater than the predetermined width.

In such an embodiment, the capacitor group C4 and C5 covers a first side of the output voltage pattern P4 and a second side of the output voltage pattern P4 opposite to the first side of the output voltage pattern P4. As shown in FIG. 10, one capacitor C4 of the capacitor group C4 and C5 may cover the first side (an upper side) of the output voltage pattern P4. another capacitor C5 of the capacitor group C4 and C5 may cover the second side (a lower side) of the output voltage pattern P4.

According to an exemplary embodiment, the DC-DC converter 600 includes the capacitor group C4 and C5 disposed adjacent to the diode D and covering the first and second sides of the output voltage pattern P4 such that the EMI may be reduced due to a reverse current of the diode D. In such an embodiment, the diode D having the parasitic capacitance equal to or greater than about 30 pF with respect to the reverse voltage of about 30 V is selected so that the EMI may be reduced. In such an embodiment, the DC-DC converter is driven to be operated in the BCM such that the EMI may be reduced.

According to exemplary embodiment of the invention as described above, the EMI may be substantially reduced.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A direct-current-to-direct-current (DC-DC) converter comprising:
an inductor to which an input voltage is applied;
a diode connected to the inductor;
a switching element connected between the inductor and the diode;
a capacitor group disposed adjacent to the diode and comprising one or more capacitors; and
an output voltage pattern connected to the diode and the capacitor group and which outputs an output voltage,
wherein the capacitor group covers a first side of the output voltage pattern and a second side of the output voltage pattern opposite to the first side of the output voltage pattern.

2. The DC-DC converter of claim 1, wherein the capacitor group comprises a capacitor which covers the first side and the second side of the output voltage pattern.

3. The DC-DC converter of claim 1, wherein the capacitor group comprises:
a first capacitor which covers the first side of the output voltage pattern; and
a second capacitor which covers the second side of the output voltage pattern.

4. The DC-DC converter of claim 1, wherein
the inductor comprises a first end to which the input voltage is applied, and a second end connected to a first electrode of the diode,
the diode comprises the first electrode connected to the second end of the inductor, and a second electrode connected to a first end of the capacitor group,
the switching element comprises a control electrode connected to a driving circuit, an input electrode connected to the first electrode of the diode, and an output electrode to which a ground voltage is applied, and
the capacitor group comprises the first end connected to the second electrode of the diode, and a second end to which the ground voltage is applied.

5. The DC-DC converter of claim 4, further comprising:
a first resistor comprising a first end connected to the first end of the capacitor group, and a second end connected to a feedback node;
a second resistor comprising a first end connected to the feedback node, and a second end to which the ground voltage is applied,
wherein the feedback node is connected to the driving circuit.

6. The DC-DC converter of claim 5, wherein
the first end of the first resistor is connected to the output voltage pattern, and
the first end of the first resistor is disposed on an opposite side of the diode with respect to the capacitor group.

7. The DC-DC converter of claim 1, wherein the capacitor group comprises a multilayer ceramic capacitor.

8. The DC-DC converter of claim 1, wherein the diode has a parasitic capacitance equal to or greater than about 30 picofarads when a reverse voltage of the diode is about 30 volts.

9. The DC-DC converter of claim 1, wherein the DC-DC converter is operated in a boundary current mode corresponding to a boundary of a continuous current mode and a discontinuous current mode.

10. A display apparatus comprises:
a display panel displaying an image;
a direct-current-to-direct-current (DC-DC) converter comprising:
an inductor to which an input voltage is applied;
a diode connected to the inductor;
a switching element connected between the inductor and the diode;
a capacitor group disposed adjacent to the diode and comprising one or more capacitors; and
an output voltage pattern connected to the diode and the capacitor group and which outputs an output voltage; and
a display panel driver which drives the display panel using the output voltage of the DC-DC converter,
wherein the capacitor group covers a first side of the output voltage pattern and a second side of the output voltage pattern opposite to the first side of the output voltage pattern

11. The display apparatus of claim 10, further comprising:
a light source part which provides light to the display panel; and
a light source driver which drives the light source part using the output voltage of the DC-DC converter.

12. The display apparatus of claim 10, wherein the capacitor group comprises a capacitor which covers the first side and the second side of the output voltage pattern.

13. The display apparatus of claim 10, wherein the capacitor group comprises:
a first capacitor which covers the first side of the output voltage pattern; and
a second capacitor which covers the second side of the output voltage pattern.

14. The display apparatus of claim 10, wherein
the inductor comprises a first end to which the input voltage is applied, and a second end connected to a first electrode of the diode,
the diode comprises the first electrode connected to the second end of the inductor, and a second electrode connected to a first end of the capacitor group,
the switching element comprises a control electrode connected to a driving circuit, an input electrode connected to the first electrode of the diode, and an output electrode to which a ground voltage is applied, and
the capacitor group comprises the first end connected to the second electrode of the diode, and a second end to which the ground voltage is applied.

15. The display apparatus of claim 14, further comprising:
a first resistor comprising a first end connected to the first end of the capacitor group, and a second end connected to a feedback node;
a second resistor comprising a first end connected to the feedback node, and a second end to which the ground voltage is applied,
wherein the feedback node is connected to the driving circuit.

16. The display apparatus of claim 15, wherein
the first end of the first resistor is connected to the output voltage pattern, and
the first end of the first resistor is disposed on an opposite side of the diode with respect to the capacitor group.

17. The display apparatus of claim 10, wherein the diode has a parasitic capacitance equal to or greater than about 30 picofarads when a reverse voltage of the diode is about 30 volts.

18. The display apparatus of claim 10, wherein the DC-DC converter is operated in a boundary current mode corresponding to a boundary of a continuous current mode and a discontinuous current mode.
